(19) United States
(12) Patent Application Publication
(10) Pub. No.: US 2009/0214176 A1
(43) Pub. Date: Aug. 27, 2009

(54) Information processing apparatus, information processing method, and program

(75) Inventor: Atsushi Sugama, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/378,947

(22) Filed: Feb. 20, 2009

(30) Foreign Application Priority Data
Feb. 22, 2008 (JP) P2008-041220

(51) Int. Cl. H04N 5/91; G06F 3/048

(52) U.S. Cl. 386/69; 715/723

(57) ABSTRACT

Disclosed herein is an information processing apparatus for use when a content and first navigation data defining a first reproduction pattern for the content are recorded on a first recording medium subject to edit constraints, the information processing apparatus including: a creation section configured to create second navigation data defining a second reproduction pattern for the content; and a recording control section configured to exercise control in order to record the second navigation data created by the creation section as meta data to a second recording medium separate from the first recording medium.

### CROSS REFERENCES TO RELATED APPLICATIONS

The present invention contains subject matter related to Japanese Patent Application JP 2008-041220 filed with the Japan Patent Office on Feb. 22, 2008, the entire contents of which being incorporated herein by reference.

### BACKGROUND OF THE INVENTION

1. Field of the Invention

The present invention relates to an information processing apparatus, an information processing method, and a program. More particularly, the invention relates to an information processing apparatus, an information processing method, and a program for changing reproduction patterns of contents recorded on recording media subject to edit constraints.

2. Description of the Related Art

At present, there exist a plurality of application formats including DVD-Video and DVD-VR destined for DVD (Digital Versatile Disk) videos to be edited (e.g., see Japanese Patent Laid-open No. 2004-05481).

### SUMMARY OF THE INVENTION

Such different application formats have different characteristics. For example, if the titles recorded by a DVD recorder have been copied to a DVD disk in the DVD-VR format, the disk can be subsequently edited. If the titles have been copied to a DVD disk in the DVD-Video format and finalized in that format, then the disk cannot be edited thereafter.

It might happen that TV programs recorded by a DVD recorder have been copied unedited to a DVD disk in the DVD-Video format. The user may then find it inconvenient to, say, fast-forward commercial scenes every time they are encountered during reproduction from the DVD disk. It might also happen that TV programs recorded on a DVD disk by someone else and given to the user turn out to be unedited and in the DVD-Video format. This also results in similar inconvenience for the user getting the TV programs reproduced from the disk.

The above problems can happen frequently. That is because general users are not necessarily well-versed in the DVD standards.

Similar problems are expected not only with DVD disks in the DVD-Video formats but also with other recording media subject to edit constraints. The problems recur because it has been impossible to change reproduction patterns for the content recorded on the recording media subject to edit constraints.

The present invention has been made in view of the above circumstances and provides arrangements for changing. reproduction patterns for the content recorded on the recording media subject to edit constraints.

In carrying out the present invention and according to one embodiment thereof, there is provided an information processing apparatus for use when a content and first navigation data defining a first reproduction pattern for the content are recorded on a first recording medium subject to edit constraints, the information processing apparatus including: a first recording medium configured to create second navigation data defining a second reproduction pattern for the content; and a recording control section configured to exercise control in order to record the second navigation data created by the creation section as meta data to a second recording medium separate from the first recording medium.

Preferably, the meta data may include at least one of two categories of information, one category being constituted by chapter points and the other category by edit information.

Preferably, the information processing apparatus according to the embodiment may further include: a reproduction section configured to reproduce the content in accordance with the first navigation data; and an operation section configured to allow a user using the content reproduced by the reproduction section to perform edit operations for creating the second reproduction pattern; wherein the creation section may create the second navigation data based on the edit operations.

Preferably, the information processing apparatus of the embodiment may further include a reproduction section configured to reproduce the content in accordance with the first navigation data; wherein the creation section may detect feature information about the content reproduced by the reproduction section, before creating the second navigation data based on the detected feature information.

Preferably, the creation section may create third navigation data defining a third reproduction pattern for the content; wherein the recording control section may exercise control so that the third navigation data created by the creation section is recorded to the second recording medium as another meta data separate from the meta data.

According to another embodiment of the present invention, there is provided an information processing method as well as a program corresponding to the inventive information processing apparatus outlined above.

The information processing apparatus above and the information processing method or program corresponding thereto are for use when a content and first navigation data defining a first reproduction pattern for the content are recorded on a first recording medium subject to edit constraints. With this setup in place, second navigation data defining a second reproduction pattern for the content is created. Control is then exercised in order to record the created second navigation data as meta data to a second recording medium separate from the first recording medium.

According to a further embodiment of the present invention, there is provided an information processing apparatus for use when a content and first navigation data defining a first reproduction pattern for the content are recorded on a first recording medium subject to edit constraints and when second navigation data defining a second reproduction pattern for the content is recorded on a second recording medium separate from the first recording medium, the information processing apparatus including: a creation section configured to create third navigation data by synthesizing the first navigation data and the second navigation data; and a reproduction section configured to reproduce the content in accordance with the third navigation data created by the creation section.

According to an even further embodiment of the present invention, there is provided an information processing method as well as a program corresponding to the preceding information processing apparatus of the invention. The information processing apparatus above and the information processing method or program corresponding thereto are for use when a content and first navigation data defining a first reproduction pattern for the content are recorded on a first recording medium subject to edit constraints and when second navigation data defining a second reproduction pattern for the content is recorded on a second recording medium separate from the first recording medium. With this setup in place, third navigation data is created by synthesizing the first navigation data and the second navigation data. The content is then reproduced in accordance with the created third navigation data.

According to the present invention, as outlined above, it is possible to change reproduction patterns for the content recorded on the recording medium subject to edit constraints.

### BRIEF DESCRIPTION OF THE DRAWINGS

FIG. 1 is a block diagram showing a typical structure of a recording and reproducing apparatus according to an embodiment of the present invention;

FIG. 2 is a schematic view explanatory of how the recording and reproducing apparatus of FIG. 1 works;

FIG. 3 is a schematic view showing typical meta data according to another embodiment of the present invention is applied;

FIG. 4 is a schematic view showing a typical structure of composite navigation data created by synthesizing the navigation data and meta data indicated in FIG. 3;

FIG. 5 is a schematic view explanatory of how the recording and reproducing apparatus of FIG. 1 works alternatively;

FIG. 6 is another schematic view explanatory of how the recording and reproducing apparatus of FIG. 1 works alternatively; and

FIG. 7 is another schematic view explanatory of how the recording and reproducing apparatus of FIG. 1 works alternatively.

### DETAILED DESCRIPTION OF THE PREFERRED EMBODIMENT

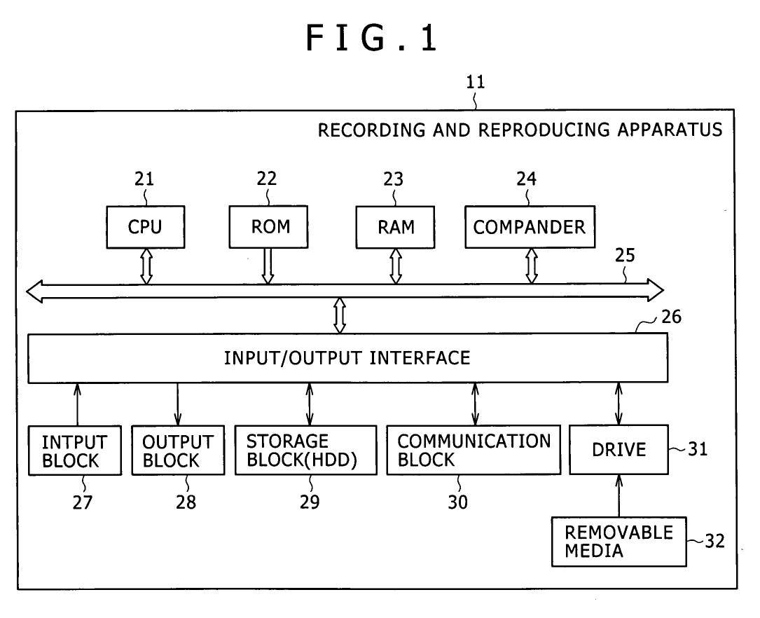

The preferred embodiment of the present invention will now be described in reference to the accompanying drawings. FIG. 1 is a block diagram showing a typical functional structure of a recording and reproducing apparatus 11 practiced as an information processing apparatus embodying the present invention.

The recording and reproducing apparatus 11 is capable of recording and reproducing contents. The contents in this context refer to an extensive range of products created by people's creative activities. The contents illustratively include movies, music, dramas, literature, photos, comics, animations and video games; letters, graphics, colors, voices, performances and pictures; any combination of the above; and program for offering information about any of the foregoing categories by way of a computer. In this specification, the contents mainly composed of pictures are called picture contents. The picture contents fall into two broad categories: still picture contents primarily made up of still pictures, and moving picture contents principally constituted by moving pictures. The description that follows will focus on such moving picture contents. That is, the ensuing description will be made on the assumption that the recording and reproducing apparatus 11 records and reproduces moving picture contents.

This specification also refers to so-called content data such as products created by people's creative activities and handled in machine-processible form (e.g., in electrical signals) or fixed to memory structures as contents without distinction from the above-mentioned varieties. In this connection, data sets such as frames and fields making up moving pictures are also called moving picture contents.

In FIG. 1, a CPU (central processing unit) 21 performs various processes in accordance with the programs held in a ROM (read only memory) 22 or in keeping with the programs loaded from a storage block 29 into a RAM (random access memory) 23. The RAM 23 also accommodates data needed by the CPU 21 in executing the processes.

A compander 24 compresses moving picture contents into compression-encoded moving picture contents in accordance with a predetermined format such as the MPEG (Moving Picture Experts Group) format, and outputs the resulting contents. In keeping with the predetermined format, the compander 24 also expands compression-encoded moving picture contents back to original moving picture contents and outputs the contents thus obtained.

The CPU 21, ROM 22, and RAM 23 are interconnected via a bus 25. An input/output interface 26 is also connected to the bus 25.

The input/output interface 26 is connected with an input block 27, an output block 28, the storage block 29, and a communication block 30. The input block 27 is typically made up of a keyboard and a mouse. The output block 28 is generally composed of a display unit. The storage block 29 and communication block 30 are usually constituted by a hard disk drive (HDD) and a modem or terminal adapter, respectively. The communication block 30 conducts communications with other apparatuses (not shown) over networks including the Internet.

A drive 31 may be connected to the input/output interface 25 as needed. A piece of removable media 32 such as magnetic disks, optical disks, magneto-optical disks or semiconductor memories may be loaded into the drive 31. Information is then exchanged between the removable medium and the apparatus.

How the recording and reproducing apparatus 11 of FIG. 1 works is described below. It is assumed in advance that there is provided a piece of removable media 32 (i.e., disk) to which a content has been copied in the DVD-Video format. This disk is called a disk 32D in distinction from the other removable media 32.

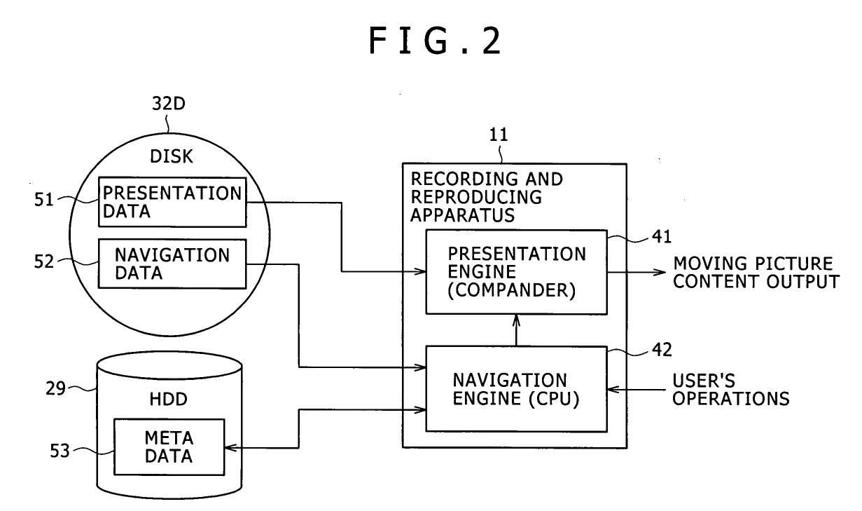

As shown in FIG. 2, presentation data 51 including the above-mentioned compression-encoded moving picture content (real data) is recorded on the disk 32D together with navigation data 52 for navigating the reproduction of the presentation data 51. This setup is basically in line with existing techniques.

There already exists the method for reproducing the presentation data 51 in accordance with the navigation data 52, both categories of data being stored on the same disk 32D. This method will be referred to as the ordinary reproduction method in the ensuing description.

When the recording and reproducing apparatus 11 reproduces the presentation data 51 by resorting to the ordinary reproduction method, the following steps are typically performed: as shown in FIG. 2, a presentation engine 41 under control of a navigation engine 42 of the apparatus 11 retrieves the presentation data 51 (compression-encoded moving picture content) from the disk 32D and decodes the retrieved data for expansion. The expansion decoding provides the moving picture content. In accordance with the navigation data 52 on the disk 32D, the navigation engine 42 controls output (i.e., reproduction) of the moving picture content by the presentation engine 41.

The presentation engine 41 in FIG. 2 is a functional block corresponding to the compander 24 in FIG. 1. The navigation engine 42 in FIG. 2 is a functional block that constitutes the capability of the CPU 2 in FIG. 1 to control reproduction of the presentation data 51.

In the past, the ordinary reproduction method was the only method for reproducing the presentation data 51. There was no method that would permit subsequent editing of the presentation data 51 in order to reproduce the edited data.

The recording and reproducing apparatus 11 of the present embodiment, by contrast, adopts both the ordinary reproduction method and a method for virtually editing the presentation data 51 subsequently in order to reproduce the edited data. The latter method is called the inventive reproduction method hereunder.

The inventive reproduction method is implemented by the recording and reproducing apparatus 11 roughly as follows: the navigation engine 42, given the user's suitable operations, controls the presentation engine 41 to first reproduce the presentation data 51 from the disk 32D. With the reproduction in progress, the navigation engine 42 creates navigation data in association with the presentation data 51 and stores the created navigation data as meta data 53 onto the HDD 29. It is thus possible subsequently to edit the presentation data virtually and store the edited data onto the HDD 29 as the meta data 53 that constitutes external navigation data.

The navigation data in this context is a file of data defining the reproduction pattern for a moving picture content (presentation data 51 for this embodiment). Illustratively, information about the presentation data 51 is defined in terms of timestamps denoting chapter points and other edit information (e.g., intervals to be skipped during reproduction). The meta data 53 is so constituted as to include these timestamps.

The meta data 53 may be created illustratively as follows: the user operates the recording and reproducing apparatus 11 to first reproduce the presentation data 51 from the disk 32D and then to perform edit operations during the reproduction. The edit operations may include inserting chapters (bookmarks) and designating the intervals to be skipped during reproduction. The navigation engine 42 of the recording and reproducing apparatus 11 recognizes the results of the user's edit operations as information made of chapter points and skip intervals defined by timestamps, and creates the meta data 53 in such a manner as to include these timestamps.

Once the meta data 53 is created as described, the presentation data 51 held on the disk 32D may be reproduced by one of two methods: by the ordinary reproduction method for reproducing the presentation data in accordance with the navigation data 52 on the same disk 32D, or by the inventive reproduction method for reproducing the presentation data in keeping with the external navigation data (e.g., meta data 53) subsequently edited by the user.

Examples of the meta data 53 will now be described. In the ensuing description, moving picture contents are assumed to be broadcast/distributed programs or movies. The presentation data 51 made up of such broadcast/distributed programs or movies is generally constituted not by a single broadcast/distributed program but by a plurality of such programs together with CMs (commercial messages) inserted for the viewer to watch at the beginning and at the end of each program as well as between the program reproduction. In most cases, such CMs and similar insertions are sequenced chronologically in accordance with the program schedules typically established by the broadcasting station. That is, the presentation data 51 for this embodiment includes not only broadcast/distributed programs or movies but also CMs (commercial messages) and other insertions associated therewith.

In the description of the presentation data 51 that follows, the broadcast/distributed program or movie may be referred to as the “main story” where appropriate. The insertions other than the main story, such as CMs inserted at the beginning and at the end of the main story as well as therebetween, may be referred to as “CM intervals.”

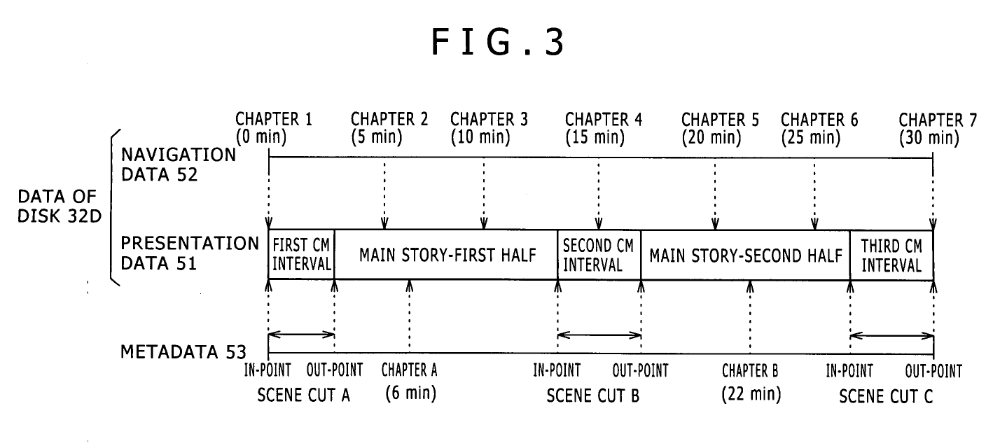

FIG. 3 schematically shows typical meta data 53. The example of FIG. 3 results from copying of a 30-minute broadcast/distributed program (title) onto the disk 32D. The presentation data 51 and navigation data 53 indicated in FIG. 3 are derived from the copying and recorded on the disk 32D.

The presentation data 51 in the example of FIG. 3 is shown to include a first CM interval, a first-half main story, a second CM interval, a second-half main story, and a third CM interval.

It can be seen that the typical navigation data 52 in FIG. 3 is structured to contain chapters inserted at intervals of five minutes. It should be noted that the positions in which the chapters are inserted are totally irrelevant to the points in time at which the main story and a CM interval are to be switched or to the important scenes of the main story. As a result, if the presentation data 51 is reproduced solely in accordance with the navigation data 52, it is impossible to skip the CM intervals during reproduction or to start reproducing the main story from one of its importance scenes. That means the problems mentioned above in connection with the summary of the invention remain unresolved.

By contrast, the meta data 53 in FIG. 3 includes information created by the user's edit operations or by an automatic creation process (to be discussed later). The information contains scene cuts and chapter points.

When reproducing the presentation data 51 in accordance with the meta data 53, i.e., when reproducing a “virtually edited” title, the recording and reproducing apparatus 11 can synthesize the navigation data 52 on the disk 32D and the meta data 53 on the HDD 29 into new navigation data (called the composite navigation data hereunder). The composite navigation data may then be used for reproduction of the presentation data 51.

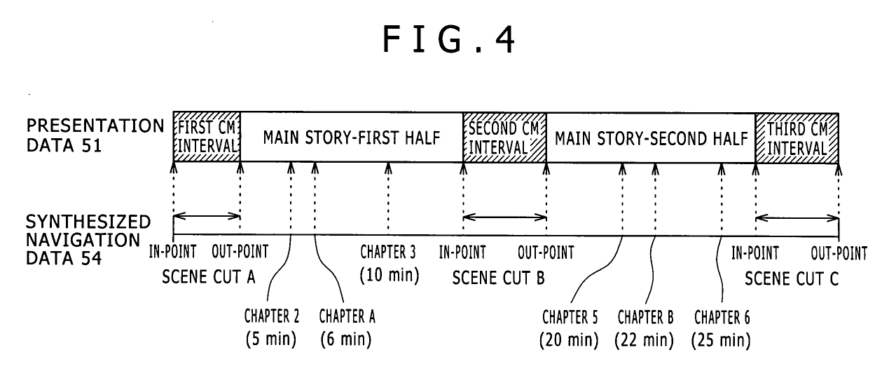

More specifically, FIG. 4 shows a typical structure of composite navigation data 54 created by synthesizing the navigation data 52 and meta data 53 indicated in FIG. 3. According to the composite navigation data 54, CM intervals are cut out during reproduction. In the main story, chapter points A and B from the meta data 53 are seen inserted in addition to the chapter points 2, 3, 5 and 6 from the navigation data 52.

In reproducing the presentation data 51 in keeping with the composite navigation data 54, the recording and reproducing apparatus 11 can then proceed with the reproduction while skipping only the CM intervals. The chapters A and B are chapters that were created by the user's editing work or by an automatic creation process (to be described later). That is to say, the starting points of important scenes may be edited into the main story as the chapters A and B. With such editing work done to prepare the composite navigation data 54, the recording and reproducing apparatus 11 may reproduce accordingly the presentation data 51 starting from an important scene of the main story. In other words, the use of the composite navigation data 54 makes it possible to resolve the problems outlined in conjunction with the summary of the invention.

Illustratively, if the recording and reproducing apparatus 11 has a capability to extract feature information from presentation data, then the apparatus 11 can create the meta data 53 automatically. That is, there is no need for the apparatus 11 to relay on the user for editing work.

There are no specific constraints on feature information or on the methods for extracting it. For example, CM intervals may serve as feature information that can be detected. This arrangement may be implemented using a suitable method for detecting CM intervals which, when detected, constitute relevant feature information.

The suitable CM interval detection method may obviously be any one of a variety of existing methods for that purpose. Alternatively, any one of other methods that may be developed in the future may be adopted as the preferred CM interval detection method. In other words, the CM interval detection method itself is not an important element of an embodiment of the present invention. What follows is a brief description of one known method for detecting CM intervals.

Generally, broadcast programs and CMs contain not only pictures but also sounds. For that reason, the recording and reproducing apparatus 11 is designed to acquire not only video signals but also audio signals as the signals that make up such broadcast programs and CMs. Several audio modes are provided for the audio signal. In many cases, the audio mode for CMs is stereo mode whereas the mode for broadcast programs is monaural mode or sound multiplex mode. With these technical aspects taken into account, the recording and reproducing apparatus 11 detects audio mode information as feature information, recognizing the intervals in stereo mode as CM intervals (i.e., thereby detecting CM intervals). Details of this CM interval detection method are disclosed illustratively by Japanese Patent No. 2858758.

By adopting this type of CM interval detection method, the recording and reproducing apparatus 11 can easily create such information as scene cuts A and B in FIG. 3.

As another example, those points in the moving picture content which represent certain features (called feature points hereunder) may be adopted as feature information. In this case, the recording and reproducing apparatus 11 detects such feature points during reproduction of the moving picture content (presentation data 51 for this embodiment) and adopts the detected points as chapter points. A chapter point is a point in time at which a chapter is inserted.

More specifically, while the moving picture content is being reproduced, the content takes the form of a video baseband signal or an audio PCM signal at certain points in time. At each of these points in time, the recording and reproducing apparatus 11 analyzes the video baseband signal or audio PCM signal in predetermined units (e.g., in units of frames, GOPs, or chunks) to detect their feature quantities and recognizes chronological transition of the detected feature quantities. Based on the result of the recognition process, the recording and reproducing apparatus 11 detects feature points. Using these feature points as chapter points, the recording and reproducing apparatus 11 can then create easily the information indicative of the chapter points such as chapters A and B in FIG. 3.

The meta data 53, as mentioned above, comes in the form of a file of data defining a reproduction pattern for the moving picture content (i.e., presentation data 51 for this embodiment). Thus one set of meta data 53 can be used to reproduce the target data in one reproduction pattern only. Some users, however, may wish to reproduce one original moving picture content (presentation data 51) in a plurality of reproduction patterns. Such user preferences can be met by the recording and reproducing apparatus 11 creating a plurality of sets of meta data 53 which define a plurality of reproduction patterns and which are recorded to a single disk 32D (along with the presentation data 51).

The user may thus perform editing work on one disk 32D as many times as desired for different effects. If there are a plurality of titles on the disk 32D (i.e., a plurality of sets of presentation data 51), then it is possible to prepare a plurality of play lists with different contents (together with meta data 53 corresponding to the play lists).

As described above, the meta data 53 refers to “external navigation data,” separate from the navigation data 52 recorded on the disk 32D. That means the meta data 53 may be stored on the HDD 29 or in any other suitable location.

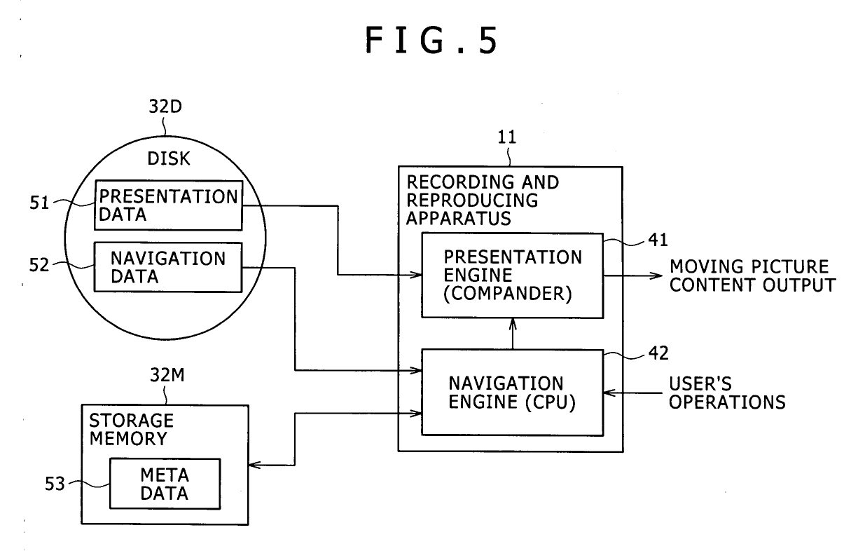

As shown in FIG. 5, the recording and reproducing apparatus 11 can easily record the meta data 53 illustratively to an external recording medium such as a memory card or to some other appropriate storage medium 32M (e.g., removable HDD).

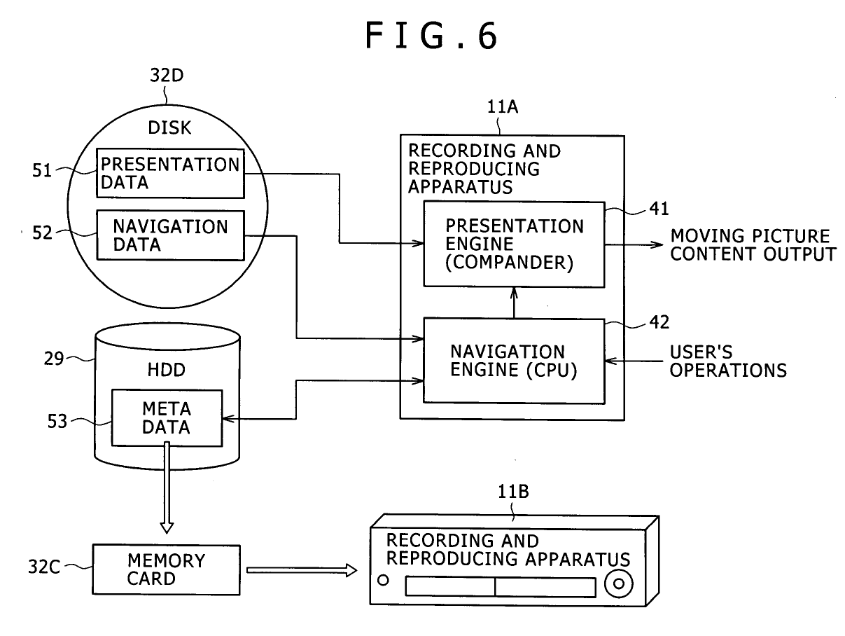

According to an embodiment of the present invention, it might happen that the recording and reproducing apparatus 11 is constituted by two recording and reproducing apparatuses 11A and 11B as indicated in FIG. 6, for example. In such a case, the meta data 53 stored on the HDD 29 in one recording and reproducing apparatus 11A can be copied to a piece of removable media 32 (memory card 32C in the example FIG. 6). The other recording and reproducing apparatus 11B can then reproduce the navigation data 52 in accordance with the meta data 53 using both the disk 32D and the memory card 32C being loaded.

The meta data 53, once created, can be readily recorded to the removable media 32. That means the user can remove and carry around the removable media 32 and disk 32D. In other words, the user may take the meta data 53 out of one recording and reproducing apparatus 11A and move it to the other recording and reproducing apparatus 11B. The other recording and reproducing apparatus 11B may then be operated to reproduce the presentation data 51 in keeping with the same meta data 53.

The method for moving the meta data 53 from one recording and reproducing apparatus (11A) to another (11B) is not limited to the physical intervention of the removable media 53 as in the case of FIG. 6. Alternatively, the meta data 53 may be transferred between apparatuses by means of communication. The technique of communication is not limited to anything specific. Illustratively, the data may be transferred directly through infrared ray communication or over networks such as the Internet.

The meta data 53 signifies navigation data that defines a reproduction pattern. The reproduction pattern is not limited to a pattern in which to reproduce a single set of presentation data 51; the pattern may be one in which part or all of a plurality of sets of presentation data 51 are reproduced in combined fashion. In that sense, it is obviously possible to create meta data 53 spanning a plurality of disks 32D (having a plurality of sets of presentation data 51 stored thereon).

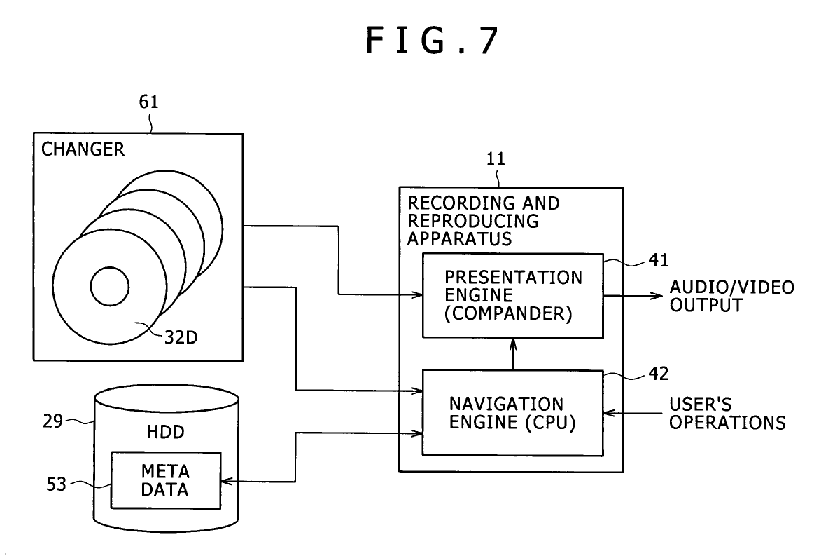

More specifically, the recording and reproducing apparatus 11 may be a type of apparatus with a changer capability, i.e., the ability to accommodate a plurality of disks 32D simultaneously and to let any one of them be driven for data reproduction. Suppose that as shown in FIG. 7, the recording and reproducing apparatus 11 is equipped with a changer 61. In that case, the recording and reproducing apparatus 11 creates meta data 53 spanning a plurality of disks 32D being loaded in the changer 61 and has the created meta data 53 recorded illustratively to the HDD 29. This makes it possible to use a single set of meta data 53 in managing integrally the multiple disks 32D containing an extra-long movie or a series of dramas. The user then feels as if a single moving picture content is being reproduced out of multiple content elements. It is also easy to reproduce the content continuously while the disks 32D are being changed automatically.

As described above, it might happen that the disk 32D subject to edit constraints has the presentation data 51 stored thereon as the real data of a moving picture content together with the navigation data 52 defining a first reproduction pattern for the moving picture content. In that case, the recording and reproducing apparatus 11 according to the embodiment the present invention can create second navigation data defining a second reproduction pattern for the moving picture content and record the created second navigation data to a recording medium such as the HDD 29 separate from the disk 32D.

The inventive structure above provides a variety of advantages. Illustratively, the user can edit the disk 32D as if he or she were editing titles stored on the HDD 29 or the like.

As another advantage, the user can virtually edit the disk 32D without ripping data therefrom.

As a further advantage, virtual editing work can be performed independently of the application format specific to the disk 32D.

As an even further advantage, virtual editing work can be done on the disk 32D prepared in a format other than the DVD-Video format, with no need to re-edit the disk itself.

As a still further advantage, it becomes easy to cut out CM intervals and/or to prepare a digest of the content of interest.

As a yet further advantage, a plurality of sets of meta data 53 may be created for a single disk 32D. This makes it possible to prepare multiple files of differently edited effects for the same content.

As another advantage, the meta data 53 may be taken out of the apparatus on which it was first created. The copied meta data 53 may then be transferred to another apparatus with the same functionality so that the latter may reproduce the content of the disk as edited previously on the other apparatus.

As a further advantage, the meta data 53 may be created in such a manner as to associate a plurality of disks 32D with one another for data reproduction. This feature makes it possible virtually to handle as one content those dispersed on the multiple disks 32D.

The series of steps and processes described above may be executed either by hardware or by software. Where the software-based processing is to be carried out, the programs constituting the software may be either incorporated beforehand in dedicated hardware of a computer (e.g., one with the CPU 21 in FIG. 1) for program execution or installed upon use over a network or from a suitable recording storage medium into a general-purpose personal computer or like equipment, not shown.

As shown in FIG. 1, the program recording medium is offered to users not only as the removable media (package media) 32 apart from their computers and constituted by magnetic disks (including floppy disks), optical disks (including CD-ROM (Compact Disk-Read Only Memory) and DVD (Digital Versatile Disk)), magneto-optical disks (including MD (Mini-disc)), or semiconductor memories, each medium carrying the necessary programs; but also in the form of the ROM 22 or the storage block 28, each accommodating the programs and incorporated beforehand in the computer.

In this specification, the steps describing the programs stored on the recording medium represent not only the processes that are to be carried out in the depicted sequence (i.e., on a time series basis) but also processes that may be performed parallelly or individually and not chronologically.

In this specification, the term “system” refers to an entire configuration made up of a plurality of component devices and processing elements. In other words, the recording and reproducing apparatus 11 in FIG. 1 may be considered to be an information processing system. As such, the recording and reproducing apparatus 11 may be constituted illustratively by a single apparatus, or by a plurality of apparatuses made up of an editing apparatus for creating the meta data 53 and a reproducing apparatus for reproducing contents in accordance with the created meta data 53.

It should be understood by those skilled in the art that various modifications, combinations, sub-combinations and alterations may occur depending on design requirements and other factor in so far as they are within the scope of the appended claims or the equivalents thereof.

What is claimed is:

1. An information processing apparatus for use when a content and first navigation data defining a first reproduction pattern for the content are recorded on a first recording medium subject to edit constraints, the information processing apparatus comprising:
creation means for creating second navigation data defining a second reproduction pattern for the content; and
recording control means for exercising control in order to record the second navigation data created by the creation means as meta data to a second recording medium separate from the first recording medium.

2. The information processing apparatus according to claim 1, wherein the meta data includes one of two categories of information, one category being constituted by chapter points and the other category by edit information.

3. The information processing apparatus according to claim 1, further comprising:
reproduction means for reproducing the content in accordance with the first navigation data; and
operation means for allowing a user using the content reproduced by the reproduction means to perform edit operations for creating the second reproduction pattern;
wherein the creation means creates the second navigation data based on the edit operations.

4. The information processing apparatus according to claim 1, further comprising:
reproduction means for reproducing the content in accordance with the first navigation data;
wherein the creation means detects feature information about the content reproduced by the reproduction means, before creating the second navigation data based on the detected feature information.

5. The information processing apparatus according to claim 1, wherein the creation means creates third navigation data defining a third reproduction pattern for the content; and
wherein the recording control means exercises control so that the third navigation data created by the creation means recorded to the second recording medium as another meta data separate from the meta data.

6. An information processing method for use when a content and first navigation data defining a first reproduction pattern for the content are recorded on a first recording medium subject to edit constraints, the information processing method comprising the steps of:
causing an information processing apparatus to create second navigation data defining a second reproduction pattern for the content; and
causing the information processing apparatus to exercise control in order to record the created second navigation data as meta data to a second recording medium separate from the first recording medium.

7. A program for use when a content and first navigation data defining a first reproduction pattern for the content are recorded on a first recording medium subject to edit constraints, the program causing a computer to execute a procedure comprising the steps of:
creating second navigation data defining a second reproduction pattern for the content; and
exercising control in order to record the created second navigation data as meta data to a second recording medium separate from the first recording medium.

8. An information processing apparatus for use when a content and first navigation data defining a first reproduction pattern for the content are recorded on a first recording medium subject to edit constraints and when second navigation data defining a second reproduction pattern for the content is recorded on a second recording medium separate from the first recording medium, the information processing apparatus comprising:
creation means for creating third navigation data by synthesizing the first navigation data and the second navigation data; and
reproduction means for reproducing the content in accordance with the third navigation data created by the creation means.

9. An information processing method for use when a content and first navigation data defining a first reproduction pattern for the content are recorded on a first recording medium subject to edit constraints and when second navigation data defining a second reproduction pattern for the content is recorded on a second recording medium separate from the first recording medium, the information processing method comprising the steps of:
causing an information processing apparatus to create third navigation data by synthesizing the first navigation data and the second navigation data; and
causing the information processing apparatus to reproduce the content in accordance with the created third navigation data.

10. A program for use when a content and first navigation data defining a first reproduction pattern for the content are recorded on a first recording medium subject to edit constraints and when second navigation data defining a second reproduction pattern for the content is recorded on a second recording medium separate from the first recording medium, the program causing a computer to execute a procedure comprising the steps of:
creating third navigation data by synthesizing the first navigation data and the second navigation data; and
reproducing the content in accordance with the created third navigation data.

11. An information processing apparatus for use when a content and first navigation data defining a first reproduction pattern for the content are recorded on a first recording medium subject to edit constraints, the information processing apparatus comprising:
a creation section configured to create second navigation data defining a second reproduction pattern for the content; and
a recording control section configured to exercise control in order to record the second navigation data created by the creation section as meta data to a second recording medium separate from the first recording medium.

12. An information processing apparatus for use when a content and first navigation data defining a first reproduction pattern for the content are recorded on a first recording medium subject to edit constraints and when second navigation data defining a second reproduction pattern for the content is recorded on a second recording medium separate from the first recording medium, the information processing apparatus comprising:
a creation section configured to create third navigation data by synthesizing the first navigation data and the second navigation data; and
a reproduction section configured to reproduce the content in accordance with the third navigation data created by the creation section.
